(19) United States
(12) Patent Application Publication
(10) Pub. No.: US 2013/0259285 A1
(43) Pub. Date: Oct. 3, 2013

(54) Loudspeaker system, Audio Recovery Imaging Amplifier

(71) Applicants: Joseph B. Crosswell, Boone, NC (US); William J. Godwin, Deep Gap, NC (US)

(72) Inventors: Joseph B. Crosswell, Boone, NC (US); William J. Godwin, Deep Gap, NC (US)

(21) Appl. No.: 13/430,926

(22) Filed: Mar. 27, 2012

(51) Int. Cl. H04R 1/20; H04R 1/02

(52) U.S. Cl. 381/345

(57) ABSTRACT

A loudspeaker system designed to minimize the enclosure to fit in furniture and exceed high end fidelity sound found in larger and more complex systems. The system presented herein incorporates a sealed enclosure utilizing two small diameter audio drivers, 3″ or larger depending on application, and a passive radiator, ported into a bass chamber with a tuned port. The two drivers are wired 180 degrees out of phase, aligned on the central axis, but facing opposite directions, resulting in a push-pull alignment. With the sealing of the enclosure, the internal driver becomes a static engine that projects the image of the sound stage while reducing the mechanical excursion, allowing higher SPL levels and more accurate reproduction of all frequencies in a small enclosure.

### FIELD OF THE INVENTION

The present invention relates to loudspeakers and systems for the high fidelity reproduction of sound and how the invention can be employed in close proximity, as in furniture, but can also be applied to near field technology.

### BACKGROUND

Audio reproduction incorporates the original designs of transducers, employing magnets and cone materials to transfer the electronic waves through voice coils, moving the cone material to produce audible sounds the ear can understand. To overcome the back-wave problems inherent with transducers, enclosures of all sorts have been developed, with varying formulas and mathematical theories to improve the output of the transducers.

A push pull design was developed and applied in various patents, since the 1920's, exampled by U.S. Pat. No. 4,016,953. This patent describes the loudspeakers in a design that uses the loudspeakers facing each other, with same phasing, and also facing opposite directions and out of phase. This allows the two to act as one. Even with the improved response, the remaining need is with the low frequency reproduction.

Engineers, inventors, and mathematicians have creatively changed and improved the equations dealing with low frequencies, but the paradigm has not changed. The current technology incorporates large enclosures, or large sized loudspeakers, or a combination of both to produce the low frequency response required for the current market. This can be seen in U.S. Pat. No. 5,815,589, where the push-pull is linked with a transmission line bass chamber to tune and use the lows generated by the back wave. Different shapes and chambers are well documented in bass reflex design, using many innovative and unique ideas. When passive radiators are incorporated into the design, as in U.S. Pat. No. 7,974,431, they are normally ported to surrounding air. It is an improvement to chamber the passive radiator and port those frequencies.

There are many examples of similar ideas and designs in classes 181 and 381, but none were found incorporating an internal driver as an engine, both to amplify the sound-stage image and internally control the excursion tendencies of the driver ported to the air.

### SUMMARY OF THE INVENTION

This design incorporates an audio experience comparable to very high-end and expensive systems. During system development, several designs were used, but all required the use of sub-woofers for low frequency reproduction. As the goal was a loudspeaker system that can easily be installed into a piece of furniture, a more unique design was required.

This design is a loudspeaker system that reduces the size required for both a bass chamber and air volume requirements for commonly produced audio drivers, resulting in an enclosure small enough to install in furniture. It also embodies substantial improvements in imaging and natural audio reproduction, and produces superior performance in SPL levels and sound field spatial areas. Because of the reduced size, installation in chairs is not only possible, but desirable. Due to the high fidelity and high quality of sound reproduction, the invention opens up a field of application before neither practicable nor exploited.

When applied to close proximity applications, one embodiment of this disclosure eliminates the need for an electronic crossover network, by employing full range drivers. Because there is no need to fill a room, the desirable frequencies are fully reproduced by selecting appropriate existing drivers. The invention includes a solution for mid to low frequency single driver problems by amplifying these frequencies, producing seamless reproduction of introduced electronic signals and further reducing the needed size of an enclosure.

Another embodiment of this disclosure is the amplification of the characteristics of drivers to the point that electronic manipulation of the audio signals is minimized resulting in accurate and natural reproduction of sound. Running a preamp with “flat” tone settings is preferred. By increasing the size of the drivers in the engine, the amplification of the sound-stage image is great enough to compete with existing commercial speaker designs, but maintains relatively small enclosures.

### DESCRIPTION OF DRAWINGS

An explanation of the invention is further understood by the attached drawings. They also show the simplicity of concept and flexibility in application.

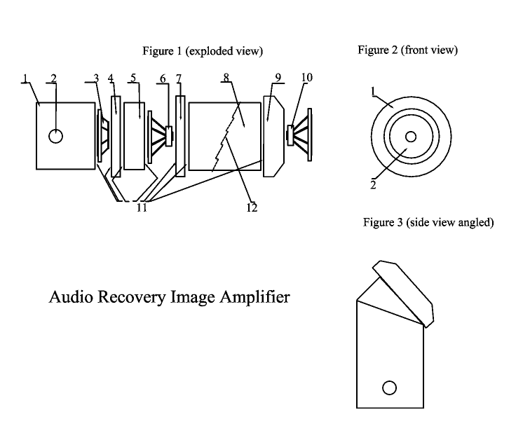

By incorporating a tubular enclosure (FIG. 2), all drivers are essentially aligned by the central axis, even when front driver (FIG. 1-10) is angled for furniture installation.

1) FIG. 1-1 is the bass chamber which is sealed except for (FIG. 1-2) which is a tuned port for the low frequencies.

2) FIG. 1-3 is a passive radiator essentially aligned with driver 2.

3) FIG. 1-4 is the third baffle used to mount the passive radiator, second cylinder, and bass chamber.

4) FIG. 1-5 is cylinder 2, varying in length per driver size, and forms the cavity between the passive radiator and driver 2.

5) FIG. 1-6 is driver 2, or the internal driver.

6) FIG. 1-7 is the baffle 2, used to mount driver 2, cylinder 2, and cylinder 1.

7) FIG. 1-8 is cylinder 1 which forms the sealed enclosure between driver 2 (FIG. 1-6) and driver 1 (FIG. 1-10). These drivers are mounted with magnets facing each other and wired out of phase to produce the push-pull configuration.

8) FIG. 1-9 is baffle 1, used to mount driver 1, and cylinder 1.

9) FIG. 1-10 is driver 1, ported to the surrounding air

10) FIG. 1-11 shows the surfaces that are sealed air tight to produce the engine.

11) FIG. 1-12 shows suggested cut line for angled assembly in FIG. 3.

12) FIG. 2-1 shows the shape of the enclosure and FIG. 2-2 is driver 1.

13) FIG. 3 shows the side view of the invention with an angle on the front driver for chair installation.

### DETAILED DESCRIPTION

The invention includes a push-pull configuration which satisfied part of the desired goal of size reduction, but did not solve the issue of producing low frequency reproduction in a small enclosure. A passive radiator was added with another cavity to port the second driver, turning it into an internal driver, and all cavities were well sealed. This produced a static air space separated from the surrounding air. The analogy of an engine can be applied with the internal driver as the equalizing and amplifying source. This came much closer to the goal. Also noted was an improved threshold of excursion in the drivers at higher SPL's. Low frequency response was greatly improved, partially due to the improved excursion of both drivers, but still needed attention.

Applying a chamber around the passive to capture the low frequencies was done for a dual purpose, relating to furniture installation. The first concern was containing the lows. The second part of the goal was directing as much of the lows into the seat containing the listener as possible while fulfilling the first concern of keeping as much of the lows from the surrounding environment as possible. This applies when dealing with multiple chairs in the same room. Working with the bass chamber by completely sealing the cavity except for a port, and tuning the port correctly, produced extraordinary bass in a small enclosure, with some directional control, suitable for installation into furniture; no sub-woofer required.

To maintain the smallest enclosure possible, we have thrown out the assumptions of the current paradigm, especially dealing with air volumes and back waves. Our design compresses the air into a sealed static enclosure by having the internal driver (FIG. 1-5) fire directly into the passive radiator. The characteristics of the passive radiator limit the mid to high frequencies from being reproduced into the environment, thus minimizing upper frequency issues between the internal and air ported first driver. Thus the engine controls over-excursion on the first driver (FIG. 1-8) by equalizing the back waves and their load on the driver, virtually eliminating the changing loads resulting from open air. The result is more SPL's from both drivers without damage to the mechanical properties of the drivers.

Due to the smallness of the bass chamber, the need to compensate for refracted and reflected back waves is minimized. The result is a pure and natural bass reproduction far superior to other designs.

Commonly accepted mathematical equations for air volume and enclosure shape for low frequency response do not work for small enclosures, so we went outside of the known paradigm and reduced volumes to minimal amounts, with more concern for overall size. This concept is used for single drivers, but usually coupled with separate enclosures for mid to low bass needed for full spectrum reproduction. (Full spectrum as in 40 HZ to 16 KHz+) This invention includes full spectrum reproduction in one small enclosure.

The use of full range drivers has eliminated the need for electronic crossovers. Individual drivers inherently possess distinct characteristics; so many different commonly available makes of drivers have been tested. We have discovered that this design works on all different size drivers. Increasing the size of the driver introduces even more advantages in SPL levels and amplification of the sound stage and resulting image. Another advantage in sound quality is combining different sized (due to driver size) completed engines. The results are a combination of the qualities of each engine, with additions in spectrum reproduction instead of subtractions in frequencies that often occur with phasing issues encountered with placing drivers in close proximity.

The overall result of this invention includes an elongated sound stage on all three axis, x, y, and especially z, with superior full range frequency response, in a small enclosure. This makes the installation into furniture possible without sacrificing any frequency response and creating a new audio experience we call close proximity. However, our research shows that the benefits of this engine can be enjoyed in near field installations just as well, when driver size is varied.

“This description of the preferred embodiments of the invention is to be considered as illustrative, and not as limiting. Various changes will occur to those skilled in the art for performing substantially the same function, in substantially the same way, to achieve substantially the same result without departing from the true scope of the invention as defined in the claims.”

1) A loudspeaker system, comprising; an enclosure including first and second audio speakers having a front and back and central axis; also including first, second, and third baffles comprised of acoustically dead materials; also including first and second tubular cylinders comprised of acoustically dead materials; also including a passive radiator consisting of a diaphragm and a supporting system supporting the diaphragm in a manner which allows the diaphragm to vibrate; also including a ported bass cavity.

2) A loudspeaker system according to claim 1;
wherein at one end of said enclosure, said first audio speaker is attached to said first baffle where front of said first audio speaker is ported to surrounding air;
wherein said first baffle is attached to said first tubular cylinder on side of baffle with back of said first audio speaker, where first tubular cylinder is 4 inches to 6 inches long;
wherein the opposite end of said first tubular cylinder is attached to second said baffle;
wherein on the opposite side of said second baffle is attached said second audio speaker, where front is facing 180 degrees from the said first audio speaker and central axis are essentially aligned, and second said audio speaker is ported into said second tubular cylinder;
wherein second tubular cylinder is attached to same surface as second audio speaker on said second baffle;
wherein said second tubular cylinder is attached to third baffle;
wherein on opposite side of third baffle passive radiator is attached so diaphragm is facing essentially same direction as second audio speaker, being also essentially aligned with central axis of second audio speaker;
wherein on the third baffle, same side as the passive radiator, attached is the ported bass chamber comprising the opposite end of enclosure.

3) A loudspeaker system according to claim 2, wherein said two audio speakers are out of phase to produce a push-pull configuration.

4) A loudspeaker system according to claim 2, wherein all parts of enclosure are sealed with various means to produce an airtight enclosure except for the port in the bass cavity.
